(19) United States
(12) Patent Application Publication
(10) Pub. No.: US 2012/0085182 A1
(43) Pub. Date: Apr. 12, 2012

(54) VALVE FOR COLLECTING A SAMPLE FROM THE CONTENTS OF A CONTANER

(76) Inventor: Günter Untch, Müllheim (DE)

(21) Appl. No.: 13/265,081

(22) PCT Filed: Mar. 25, 2010
(86) PCT No.: PCT/EP2010/001880

§ 371 Date: Dec. 20, 2011

(30) Foreign Application Priority Data
Apr. 24, 2009 (DE) 102009018566.6

(51) Int. Cl. G01N 1/00

(52) U.S. Cl. 73/863.86

(57) ABSTRACT

A valve for collecting a sample from a contents of a container is provided. The sampling must occur without contamination. To this end, according to the described system, the valve comprises a stationary part securely connected to the tank, a mobile part releaseably connected to the stationary part, and an actuating mechanism for switching between a base position and a switched position. The stationary part comprises a rotatably supported first partial body of a shutoff body substantially rotationally symmetrical about an axis. The mobile part comprises a rotatably supported second partial body of the shutoff body. The first partial body and/or the second partial body comprise a recess for receiving or conveying the sample.

The invention relates to a valve for collecting a sample from the contents of a container as claimed in claim 1.

Containers which contain a liquid, a gas or bulk material are frequently provided in process engineering installations of various sectors and also in other production, storage and transporting devices. Often, the containers are closed or the containers have only a small opening, which may also be difficult to access. Nevertheless, small quantities of the contents need to be collected from the containers for various reasons, for example for quality control or other analyses. Such small quantities of the contents are made available, for example to a chemical laboratory, as a sample of the contents.

Outlet slide valves or sample-taking valves, which enable a brief tapping from the container or a pipe system without disrupting the operation proceeding therein, are known. Such an outlet slide valve is known for example from DE 31 09 350 A1.

A contamination-free sample-taking system is required, for example, when the contents of the containers are hazardous substances or the contents of the containers are particularly sensitive substances which for their part must not be polluted.

The invention is based on the problem of providing a sample-collecting valve of the above-described type, which allows clean collection and holds the collected sample in an environmentally sealed manner. There must be no risk of contamination of the sample and the environment during collection.

The valve should also be as easy to handle as possible so as to enable safe collection of the sample and safe transport involving as little risk as possible and as little effort as possible.

This problem is solved according to the invention by a valve for collecting a sample from the contents of a container, having the features of claim 1.

Advantageous embodiments of the invention are given in the dependent claims.

The invention allows environmentally sealed or contamination-free collection of a sample from a container by way of a valve which has at least one stationary part connected firmly to the container, a mobile part connected detachably to the stationary part and an actuating device for switching between a basic position and a switchover position.

The expressions stationary and mobile in the designation of the stationary part and the mobile part have been selected with regard to the reference system in which the container also does not move. On the other hand, if the container and the stationary part move—i.e. if they are mobile—and if for example only the mobile part is fixed in another reference system, the expressions stationary and mobile should not be understood as absolute indications of the actual freedom of movement of the parts of the valve.

The stationary part supports a first part body of a shut-off body, which is substantially rotationally symmetrical about an axis, such that said first part body can rotate. The first part body has, facing away from the container, a first separating surface and, facing the container, a first surface, which is received partially by the stationary part in a congruent manner.

The mobile part supports a second part body of the shut-off body such that said second part body can rotate. The second part body has, facing the first separating surface of the first part body, a second separating surface. Facing away from the first separating surface, the second part body has a second surface, which is received at least partially by the mobile part in a congruent manner.

The first part body and/or the second part body has at least one recess. The recess has at least one opening, either toward the first surface or toward the second surface, in order to produce a fluid connection between the recess and the contents or a vessel.

The mobile part is secured in a docked position to the stationary part such that the first part body and the second part body are in contact with one another in each case in a region of the separating surfaces or adjacent to the separating surfaces. In this case, in advantageous embodiments, the separating surfaces are sealed off from one another, in particular by a sealing ring which is arranged between the separating surfaces, for example in annular grooves in the separating surfaces.

The first part body and the second part body can thus be rotated together in the valve by means of the actuating device. During rotation, a blocking function of the shut-off body remains intact.

Advantageously, the stationary part connected to the container remains largely clean toward the outside, even immediately after switching by means of the actuating device. When the mobile part has been removed from the stationary part, the first separating surface of the first part body is directed outward in a manner facing away from the container. Thus, it is largely certain that no contamination of the environment with the contents and no contamination of the contents themselves can take place. It is not necessary for the stationary part and the mobile part to be able to be closed with covers when they are separated from one another, but in advantageous embodiments it is provided that this be the case.

Advantageously, the recess in the shut-off body is configured to receive or pass the sample through in the switchover position. This is always ensured when the contents in the container are present at the valve. If the contents in the container are not present at the valve, a lance can be introduced into the contents of the container from the outside in particular through the recess in order to collect a sample.

The recess is located preferably in the mobile part so that the recess can be cleaned following each collection of a sample, in particular in a self-contained cleaning system, into which the entire mobile part can be inserted.

A further advantage to be mentioned is that the principle of a ball valve can be used in order to switch between the basic position and the switchover position in a particularly operationally reliable manner. Of course, other embodiments according to the invention, in which the principle involves a different form of shut-off body, are also conceivable. Thus, plates, cones or pistons are also known as shut-off bodies and are standardized in DIN EN 736-1.

Implementations according to the invention having such alternatively used shut-off bodies are thus covered by claim 1.

In an advantageous embodiment, the first part body and the second part body form two halves of a shut-off body.

Dividing the shut-off body into two halves and further processing the latter to be received in the stationary part and the mobile part, respectively, is an advantageous solution for mounting the shut-off body in the valve and is also an advantageous solution for cost reasons in the manufacture of the shut-off body.

In an advantageous embodiment, the shut-off body is substantially a sphere.

As a special form of a rotationally symmetrical body, spheres are established, with known advantages, for use in shut-off valves in process engineering installations.

In an advantageous embodiment, bearing journal halves are integrally formed in the axial direction on both sides of the shut-off body or are secured to the shut-off body.

Such bearing journal halves, which are designed advantageously as cylinder journals, make it easier to mount the respective part body in the stationary part or the mobile part. Similarly, a rotationally fixed connection to the actuating device by means of such rotationally symmetrical extensions of the shut-off body can be realized in a particularly cost-effective manner. To this end, a bearing journal half may be required only on one side of the body part.

In an advantageous embodiment, bearing elements are provided in the stationary part and the mobile part. The bearing elements support the first part body and the second part body in the corresponding stationary part and mobile part such that, at least in the basic position, the part bodies are fixed in the stationary part and the mobile part, respectively.

This securing of the position of the part bodies in the stationary part and the mobile part, respectively, is significant with respect to the safety reasons mentioned at the beginning. Precisely when it is provided for the collected sample to be transported in a recess in the mobile part, it is important to mount the second part body firmly in the mobile part so that the second part body cannot drop out of the mobile part.

In an advantageous embodiment, at least one part body is secured by means of a detent against unintentional rotation with respect to the stationary part or the mobile part. To this end, the stationary part and/or the mobile part has a lock and the detent. The lock locks the mobile part to the stationary part and, depending on whether it is locked or not, indirectly or directly releases the detent. Releasing of the detent blocks rotation of the respective body part or enables the rotation.

This has the advantage that the part bodies cannot rotate accidentally or erroneously, for example without the stationary part being connected to the mobile part.

In an advantageous embodiment, the stationary part and/or the mobile part consists at least partially of plastic.

In addition to advantages of cost-effective production of such plastic parts, the choice of material is also advantageous with regard to corrosion or reaction brought about by the contents of the containers. The durability of the valve can accordingly be increased in this manner compared with metal valves.

In an advantageous embodiment, the recess extends as a blind hole, in particular as a cylindrical blind hole, approximately perpendicularly to the axis for the rotation of the part body radially inward into the respective part body from the radially outer surface of the respective part body.

In such a recess, sampling in a manner sealed off toward the outside is ensured. A further advantage is that such blind holes are easy to produce and easy to clean.

In an advantageous embodiment, an ejector is provided in the recess. If the recess is in the form of a blind hole, the ejector can be for example a thick disk or a short cylinder. The ejector can move in the recess in order to eject a collected sample.

Such an ejector is advantageous when the sample does not drop by itself out of the recess but remains stuck therein. Virtually complete removal of the sample from the recess is then possible by way of the ejector and the sample does not have to be removed from the recess by way of further tools.

In an advantageous embodiment, the recess extends as a through-hole through one of the part bodies, with the course being formed approximately perpendicularly to the axis for the rotation of the shut-off body and approximately parallel to a separating plane of the shut-off body between the separating surfaces of the part bodies.

Such a form of the recess advantageously enables sampling through the shut-off body. This can be necessary in particular when the filling level of the container is too low so that the filling level of the contents in the container does not surpass the level of the valve. It must then be possible to engage in the container from the outside, for example. This advantageously takes place in a controlled and sealed manner through the hole.

In an advantageous embodiment, the mobile part and/or the stationary part has a suction extractor. By means of the suction extractor, air and bulk material can be largely removed from a region between the mobile part and the stationary part.

If, while switching between the basic position and the switchover position, bulk material from the contents of the container were to pass between the part bodies, the separating surfaces would be contaminated. By way of such a suction extractor, the region is cleaned before or during the separation.

In an advantageous embodiment, the mobile part has, facing away from the stationary part, a securing device. The securing device can be connected in this case to a collecting device.

Particularly advantageously, a solution is provided in this way to connecting for example sample-taking containers to the mobile part. Furthermore, the collecting device can have a vessel or be formed as such itself.

Collecting devices for holding sample-taking lances can serve as sample-taking containers. Such lances pass into the inside of the container, collect a sample and are removed from the container with the sample. In lance guides which are advantageously completely closed, this is realized in particular by telescopic guides and/or an end part having a bellows.

According to a further advantageous embodiment, the mobile part and/or the stationary part has a pressure valve. By means of the pressure valve, the pressure between the recess and/or the collecting device on one side and the environment on the other side can be equalized.

It is thus possible for the user to supply air to or remove air from the sample, which may be under a negative or positive pressure after sampling, in order to make the sample accessible to him in a controlled manner.

The valve according to the invention is used in a particularly advantageous manner in process engineering installations.

The invention is explained in more detail in the following text by way of two exemplary embodiments. In the drawings:

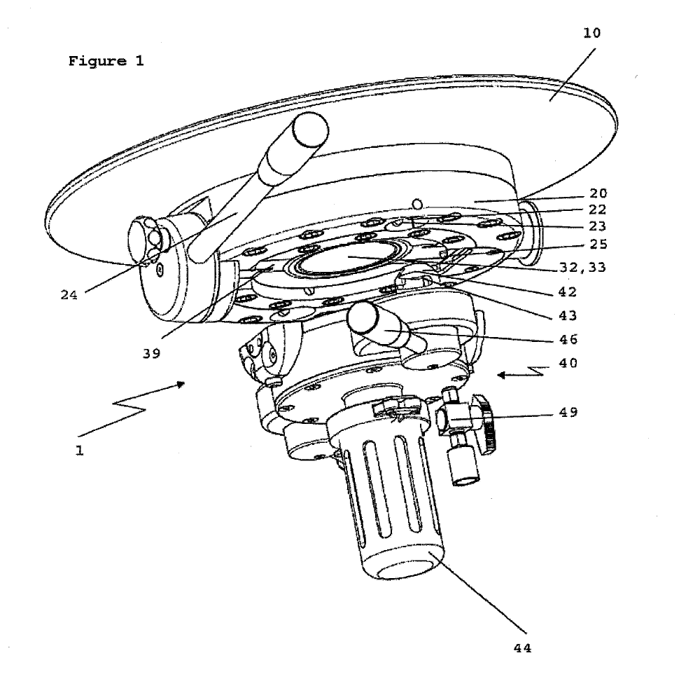

FIG. 1 shows a perspective view of a valve according to a first exemplary embodiment, wherein a mobile part has already been oriented opposite a stationary part and is standing by in a manner spaced apart from the stationary part, i.e. in a manner not yet docked therewith,

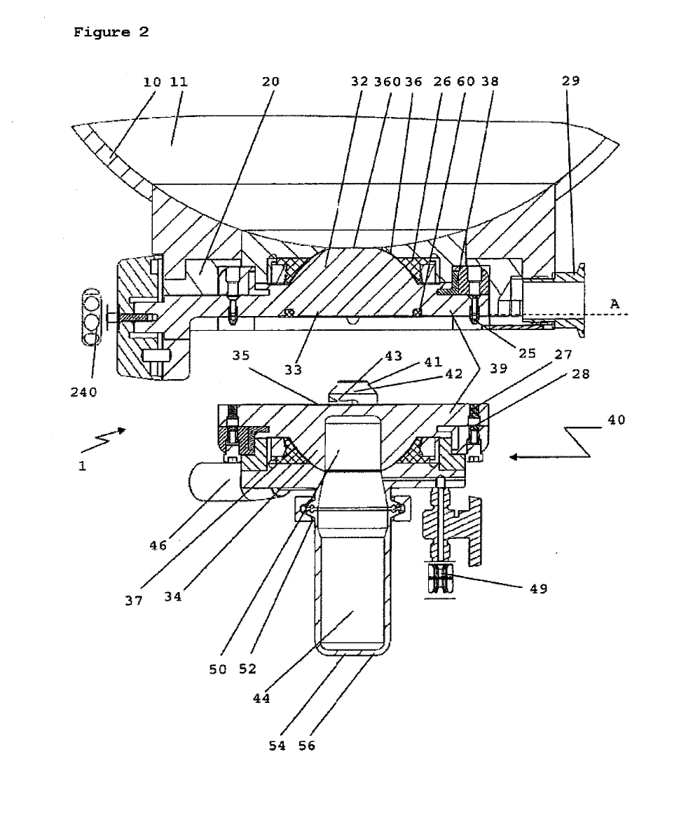

FIG. 2 shows a section through the valve from FIG. 1 along an axis A,

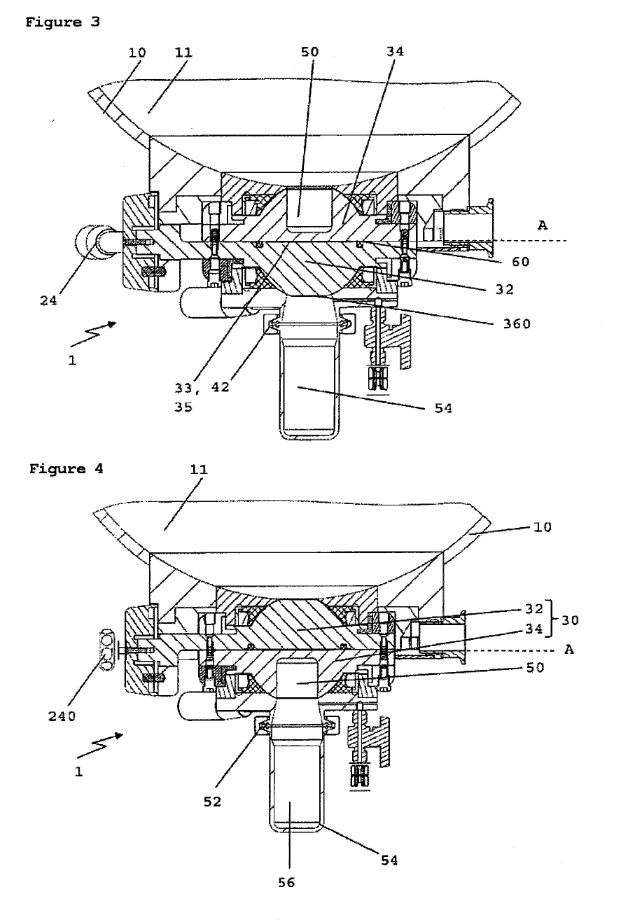

FIG. 3 shows a section through the valve from FIG. 2, wherein the mobile part has been docked with the stationary part and a shut-off body has been rotated about the axis A into a switchover position by means of an actuating device,

FIG. 4 shows a section through the valve from FIG. 3, wherein the shut-off body has been rotated into a basic position by means of the actuating device,

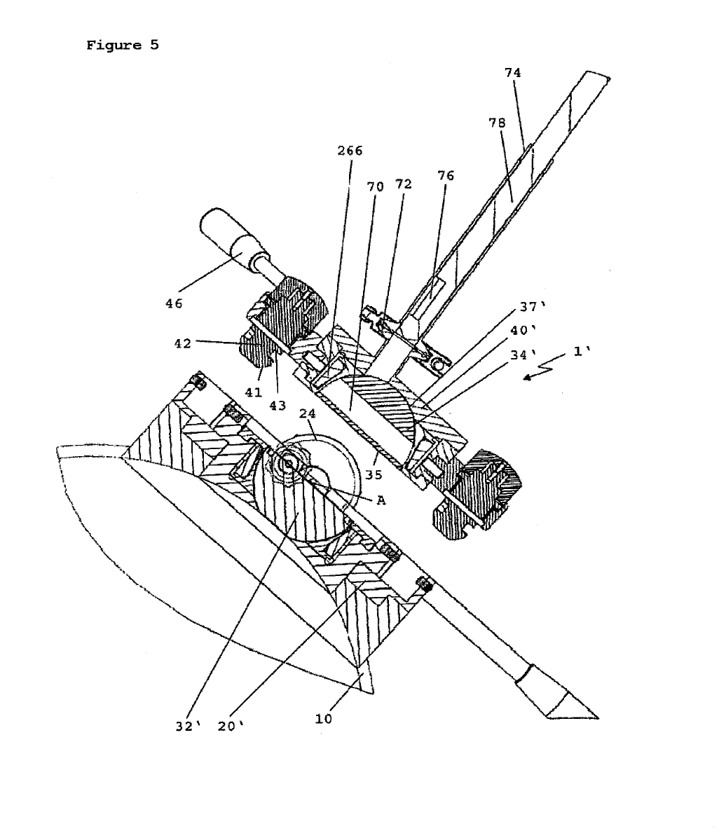

FIG. 5 shows a section through a valve according to a second exemplary embodiment, wherein the section extends perpendicularly through the axis A of the shut-off body,

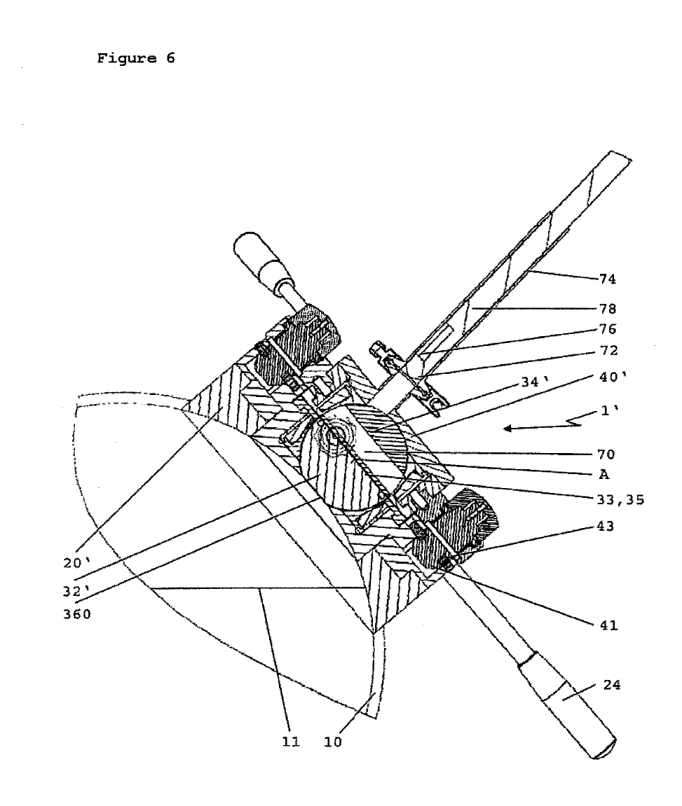

FIG. 6 shows a section through the valve from FIG. 5, wherein, unlike in FIG. 5, the mobile part has been docked with the stationary part in the basic position, and

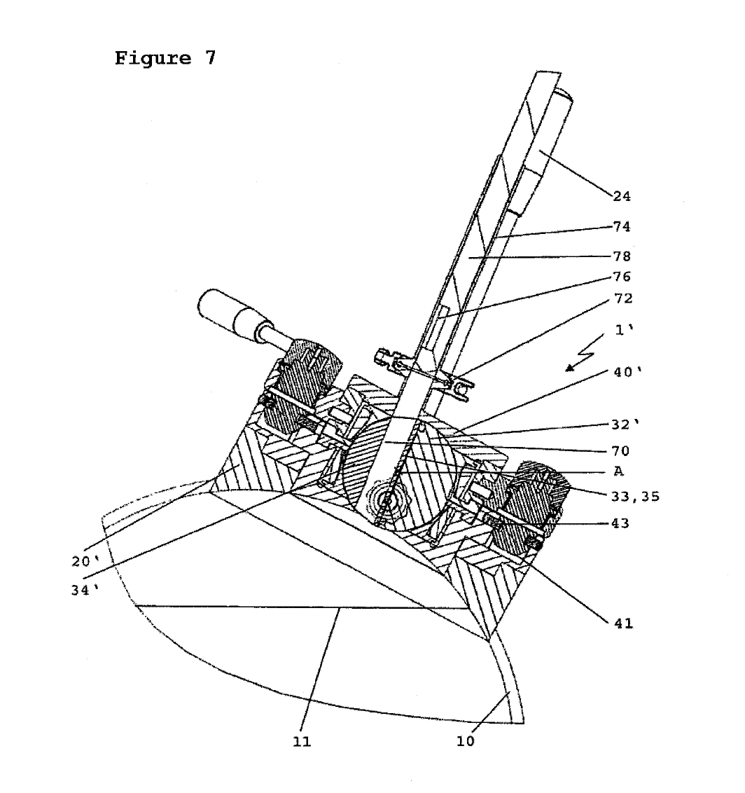

FIG. 7 shows a section through the valve from FIG. 6, wherein the shut-off body has been rotated into the switchover position by means of the actuating device.

FIGS. 1 to 4 illustrate a first exemplary embodiment of the valve 1 according to the invention. The valve 1 consists of a stationary part 20 and a mobile part 40.

In FIGS. 1 and 2, the mobile part 40 is illustrated in a manner oriented opposite the stationary part 20 but spaced apart from the stationary part 20.

The stationary part 20 is secured to a container 10 and closes the container 10 toward the outside by way of a part body 32 of a shut-off body 30. The part body 32 is connected to an actuating device 24 via bearing journal halves 39 and is mounted such that it can rotate in the stationary part 20 together with the bearing journal halves 39. The actuating device 24 is realized as a lever arm which is fitted onto the side of the stationary part 20. There is thus a rotationally fixed connection between the actuating device 24 and the shutting-off first part body 32 via the bearing journal halves 39.

The first part body 32 is mounted in the stationary part 20 such that it can rotate about an axis A. To this end, bearing elements 38 of the stationary part 20 engage in the first part body 32 so that the first part body 32 cannot drop out of the stationary part 20.

The first part body 32 has, facing the container 10, a first surface 36. The first surface 36 is received or supported at least partially in a contiguous manner by a congruent surface of the stationary part 20. The congruent surface, facing the surface 36, is guided on a seal 26 inserted in an annular manner into the stationary part 20. The surface 36 is received on the seal 26 such that the shut-off body 30 seals off the container 10 reliably from the environment.

The seal 26 is designed as an encapsulated seal. FIG. 5 illustrates the structure of the seal 26 in a cross section.

Radially on the inside, the seal 26 molds itself by way of a lip 262 between the first part body 32 and the stationary part 20. To this end, the lip 262, like the entire encapsulation 264 around a core 266 of the seal 26, is made from polytetrafluoroethylene (PTFE). The core 266 inside the encapsulation 264 consists of any desired elastomer.

The first part body 32 has, facing the container 10, a hollow 360 as a further recess in the first surface 36. The shape of the hollow 360 corresponds approximately to the bulge of the container 10. An agitator of the container 10, which brushes past the wall of said container 10, thus also brushes past the hollow 360 in an unimpeded manner in the basic position. A minimum dead space is produced on account of the hollow 360. In such a dead space, a small quantity of the contents 11 is carried along into the inside of the valve 1, 1′ while switching takes place between the basic position and the collecting position, and this can lead to pollution. This entrainment should also be understood as being a first collection of a sample, because the hollow 360 can be located above a vessel in the switchover position, when the actuating element 24 has effected a rotation through 180°.

In variants with little dead space, there is no hollow in the first surface. In order then not to disrupt free rotation of an agitator, the shut-off body is set back in the valve in the outward direction of the container.

Facing away from the container 10, the first part body 32 has a first separating surface 33. The first separating surface 33 is formed congruently to the separating plane of the spherical shut-off body 30. Alternatively, separating surfaces can also be designed in a manner diverging from the separating plane, in particular in a retreating manner. A cavity may then be produced between such separating surfaces. Depending on the working environment, such a cavity can be necessary for operational reliability, since otherwise disruptions during closure should be expected. Weight can also be saved on account of such configurations of the separating surfaces.

In a similar manner, the mobile part 40 supports a second part body 34 of the shut-off body 30. In the illustration in FIGS. 1 and 2, the second part body 34 is located opposite the first part body 32 and faces the latter. The second part body 34 is formed in a similar manner to the first part body 32. The second part body 34 differs from the first part body 32 by a recess 50. The recess 50 is designed as a cylindrical blind hole perpendicular to the axis A and perpendicular to the separating plane of the shut-off body 30.

Since in FIGS. 1 and 2 the mobile part 40 is illustrated in a manner not yet docked with the stationary part 20, the valve 1 is of course also still in the basic position. In the basic position, the recess 50, facing away from the container 10, is open toward the outside. This opening is constituted with respect to a vessel 44 such that an environmentally sealed connection is formed between the recess 50 and the vessel 44. This is ensured by a collecting device 54, which is secured to the mobile part 40 in a manner facing away from the stationary part 20.

The part bodies 32, 34 are secured against unintentional rotation with respect to the stationary part 20 or the mobile part 40 by means of at least one detent 28.

This has the advantage that the part bodies 32, 34 cannot rotate accidentally or erroneously, without the stationary part 20 being connected to the mobile part 40.

In order to secure the mobile part 40 on the stationary part 20, two locks 42 are provided opposite one another, said locks 42 functioning, according to this exemplary embodiment, on the principle of a bayonet closure. The lock 42 has a rotatable, tapered cylinder, a conical end 41 of which penetrates into a corresponding receiving hole 22 in the stationary part 20. In this case, the mobile part 40 is oriented roughly with respect to the stationary part 20 so as to reach a capturing region of a centering nipple 25. The cylinder of the lock 42 has an L-shaped groove 43, a first limb of the L of which surrounds a part of the circumference of said cylinder and a second limb of the L, at one point on the circumference, is directed in the direction of the cylinder axis and is open toward the end 41. If the cylinder penetrates into the receiving hole 22, a journal 23 integrally formed in the receiving hole 22 sinks into the groove 43. If the mobile part 40 is fitted in a centered manner on the stationary part 20, the centering nipples 25 have been introduced into corresponding holders and the cylinder can be rotated. This takes place here, as one of many options, by way of a lever 46, which is connected in a rotationally fixed manner to the cylinder. Following a rotation of the cylinder, the journal 23 is located in a region of the groove 43 in which the groove 43 allows the journal 23 no freedom of movement in the axial direction of the cylinder.

Only when the mobile part 40 has been locked to the stationary part 20 by means of the lock 42 can the actuating element 24 be rotated.

The centering nipples 25 constitute the trigger for unlocking or releasing the actuating element 24 or the bearing journal halves 39 after locking 42 of the mobile part 40 to the stationary part 20. Said centering nipples 25 are connected to pins 27 which can push a detent 28 out of the bearing journal halves 39 in the radial direction. Without the pressure transmitted by the pins 27, the detent 28 is retracted into the bearing journal halves 39 and so the bearing journal halves 39 cannot rotate in the mobile part 40. Analogously, in exemplary embodiments which are not illustrated, the bearing journal halves 39 of the stationary part 20 can be arrested.

The rotation of the actuating element 24 is monitored by a rotation monitoring device 240 such that unlocking is only enabled in the event of complete rotation of the actuating element 24 into the switchover position through approximately 90° or through 180°. Similarly, the rotation monitoring device 240 detects complete rotation through approximately 90° or 180° in order to reach a switchover position, so that a “collection taking place signal” can be emitted. Collection can thus be fully automated. The rotations through approximately 90° in order to reach a switchover position relates to the second exemplary embodiment having the recess 70, by way of which collection is then possible, in particular in the case of rotations through somewhat more than 90°.

FIGS. 3 and 4 illustrate the valve 1 in a docked position of the mobile part 40 on the stationary part 20.

FIG. 3 illustrates the first exemplary embodiment of the valve 1 in the switchover position. A rotation of the shut-off body 30, which is now composed of the part bodies 32, 34, about the axis A by means of the actuating device 24 brings about a switch into a basic position, as is illustrated in FIG. 4. The sample can now be collected from the recess 50.

The part bodies 32, 34 are in contact with one another by way of virtually clean separating surfaces 33, 35. In order to ensure that no contamination of the separating surfaces 33, 35 occurs during the switch between the basic position and the switchover position, a sealing ring 60 is provided between the part bodies 32, 34.

Following the collection of a sample, the mobile part 40 should as a rule be separated from the stationary part 20. To this end, the lock 42 is released. However, depending on the risk of contamination, this should not take place without a suction extractor 29 for extracting through the shut-off body 30 in the direction of the separating plane of the divided shut-off body 30 being switched on. Such a suction extractor 29 can be designed as a tubular suction extractor which is connected to existing vacuum systems.

The vessel 44 and the mobile part 40 are under positive or negative pressure, depending on the type of sampling. Before the vessel 44 of the collecting device 54 is opened, the pressure should thus be equalized with respect to a normal pressure. Provided to this end is a pressure valve 49, which opens and closes a fluid connection between the vessel or the recess and the environment.

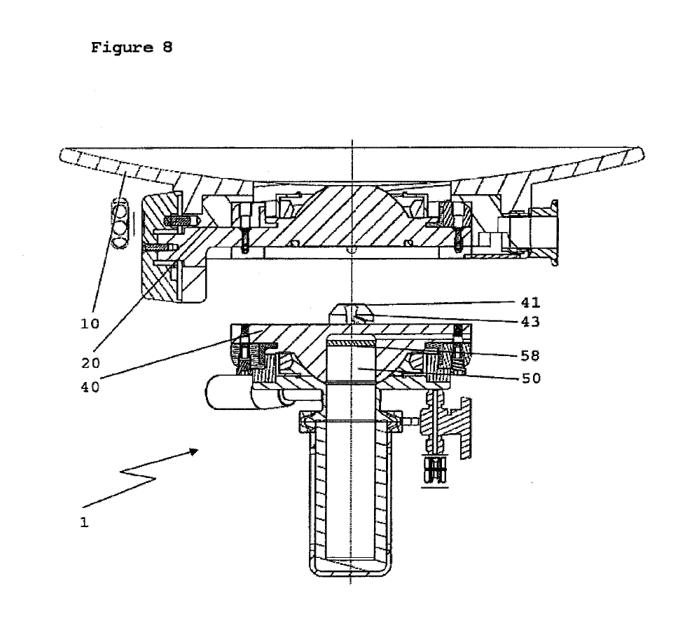

The collected sample must drop or flow from the recess 50 into the vessel 44 after being collected. This does not constitute a problem for many cases of bulk materials. However, frequently the bulk materials are viscous, sticky or lumpy material which does not readily drop out of the recess 50. The first exemplary embodiment for such problem cases with sample ejection from the recess 50 is provided in FIG. 8. To this end, a disk 58 which can move axially in the recess 50 is provided. If a sample is to be ejected from the recess 50, the disk 58 moves toward the vessel 44 perpendicularly to the axis A. This can be effected in various ways. For example, it is conceivable to apply pressure to the region on a side of the disk 58 facing away from the sample, so that pneumatic activation of the disk 58 is realized.

FIGS. 5 to 7 illustrate a second exemplary embodiment of a valve 1′ according to the invention. FIGS. 5 to 7 are sectional illustrations perpendicularly to the axis A. The stationary part 20′ and the mobile part 40′ are constructed in a manner substantially comparable to the first exemplary embodiment. The essential difference between the valve 1 and the valve 1′ consists in the recess 50, 70 in the second part body of the shut-off body 30, 30′.

According to the second exemplary embodiment (FIGS. 5 to 7), the recess 70 is designed as a through-hole through the second part body 34′ of the shut-off body 30′. The hole is located parallel to the second separating surface 35 and perpendicular to the axis A. A rotation of the shut-off body 30′ about the axis A displaces the recess 70 with its openings in the surface 37′ such that in the collecting position one of the openings is open toward the container 10 and the other of the openings produces a fluid connection to a collecting device 74.

The collecting device 74 holds a lance 78 facing away from the container 10. The lance 78 is guided in a sealed manner in the collecting device 74 so that when a fluid connection to the contents 11 of the container 10 has been established, a closed system is nevertheless provided overall. The lance 78 has, facing the container 10, a cutout, which is provided as a vessel 76 for the collected sample.

In the collecting position (FIG. 7), the lance 78 can push through the recess 70 into the container 10 and the contents 11 thereof. Once a sample has been collected, the lance 78 is pulled back in the collecting device 74 so that the shut-off body 30′ can rotate freely again. The shut-off body 30′ is rotated into a basic position so that the first separating surface 33 faces the mobile part 40′ and the container 10 is closed in a sealed manner again.

### LIST OF REFERENCE SIGNS

1, 1′ Valve

10 Container

11 Contents

20, 20′ Stationary part

22 Receiving hole

23 Journal

24 Actuating device

25 Centering nipple

26 Seal

27 Pin

28 Detent

29 Suction extractor

30, 30′ Shut-off body

32, 32′ First part body

33 First separating surface

34, 34′ Second part body

35 Second separating surface

36 First surface

37, 37′ Second surface

38 Bearing element

39 Cylinder halves

40, 40′ Mobile part

41 End

42 Lock

43 Groove

44 Vessel

46 Lever

49 Pressure valve

50 Recess

52 Securing device

54 Collecting device

56 Vessel

58 Disk

60 Sealing ring

70 Recess

72 Securing device

74 Collecting device

76 Vessel

78 Lance

240 Rotation monitoring device

262 Lip

264 Encapsulation

266 Core

360 Hollow

A Axis

1. A valve for collecting a sample from the contents of a container, comprising:
a stationary part which is firmly connected to the container, wherein the stationary part supports a first part body of a shut-off body, which is substantially rotationally symmetrical about an axis, such that said first part body can rotate is rotatable, wherein the first part body has, facing away from the container, a first separating surface and, wherein, facing the container, is a first surface, which is received partially by the stationary part in a congruent manner;
a mobile part which is connected detachably to the stationary part, wherein the mobile part supports a second part body of the shut-off body such that said second part body is rotatable about the axis, wherein the second part body has, facing the first separating surface, a second separating surface, wherein, facing away from the first separating surface, is a second surface, which is received at least partially by the mobile part in a congruent manner, and wherein at least one of: the first part body or the second part body has at least one recess, which has at least one opening, either toward the first surface or toward the second surface, in order to produce a fluid connection between the recess and the container; and
an actuating device for switching between a basic position and a switchover position.

2. The valve as claimed in claim 1, wherein the first part body and the second part body are in contact with one another.

3. The valve as claimed in claim 1, wherein the first part body and the second part body form two halves of the shut-off body.

4. The valve as claimed in claim 1, wherein the shut-off body is substantially a sphere.

5. The valve as claimed in claim 1, further comprising:
bearing journal halves integrally formed in the axial direction on both sides of the shut-off body or secured to the shut-off body.

6. The valve as claimed in claim 1, further comprising:,
bearing elements provided in the stationary part and the mobile part, said bearing elements supporting the first part body and the second part body in the stationary part and the mobile part such that, at least in the basic position, the part bodies are held in the stationary part and the mobile part, respectively.

7. The valve as claimed in claim 6, wherein the bearing elements are bushing segments having an L-shaped cross section, said bushing segments corresponding to grooves, configured in the form of ring segments, in the part bodies.

8. The valve as claimed in claim 1, wherein at least one of: the stationary part or the mobile part have a lock and a detent, wherein the lock locks the mobile part to the stationary part and the detent blocks or enables rotation of the shut-off body, and wherein the lock blocks or enables the detent indirectly, or directly.

9. The valve as claimed in claim 1, wherein at least one of the stationary part or the mobile part is made at least partially of plastic.

10. The valve as claimed in claim 1, the recess includes a cylindrical blind hole which extends approximately perpendicularly to the axis radially inward into the respective part body from the radially outer surface.

11. The valve as claimed in claim 1, wherein the recess has an ejector that is movable in the recess in order to eject a sample that has been collected.

12. The valve as claimed in claim 1, wherein the recess includes a through-hole through one of the part bodies, said through-hole extending approximately perpendicularly to the axis and approximately parallel to one of the separating surfaces.

13. The valve as claimed in claim 1, wherein at least one of: the mobile part or the stationary part has a suction extractor, wherein air and bulk material is removable from region between the mobile part and the stationary part using the suction extractor.

14. The valve as claimed in claim 1, wherein the mobile part has, facing away from the stationary part, a securing device, wherein the securing device is connectable to a collecting device.

15. The valve as claimed in claim 14, wherein the collecting device has a vessel.

16. The valve as claimed in claim 1, wherein the mobile part has a pressure valve, wherein the pressure between at least one of: the recess or the collecting device and the environment is equalizable using the pressure valve.

17. (canceled)

18. The valve as claimed in claim 2, wherein the first part body and the second part body are connected in a manner that seals one another off.

19. The valve as claimed in claim 18, further comprising:
a sealing ring that seals off the first part body and the second party body and that is disposed in a region of the separating surfaces or adjacent to the separating surfaces.

20. The valve as claimed in claim 8, wherein the lock includes pins that block or enable the detent indirectly.

21. The valve as claimed in claim 11, wherein the ejector includes a disk.

22. A method for collecting a sample from the contents of a container in a process engineering installation, comprising:
using a valve to collect the sample, wherein the valve includes:
a stationary part which is firmly connected to the container, wherein the stationary part supports a first part body of a shut-off body, which is substantially rotationally symmetrical about an axis, such that said first part body is rotatable, wherein the first part body has, facing away from the container, a first separating surface and, wherein, facing the container, is a first surface, which is received partially by the stationary part in a congruent manner;
a mobile part which is connected detachably to the stationary part, wherein the mobile part supports a second part body of the shut-off body such that said second part body can rotate about the axis, wherein the second part body has, facing the first separating surface, a second separating surface, wherein, facing away from the first separating surface, is a second surface, which is received at least partially by the mobile part in a congruent manner, and wherein at least one of: the first part body or the second part body has at least one recess, which has at least one opening, either toward the first surface or toward the second surface, in order to produce a fluid connection between the recess and the container; and
an actuating device for switching between a basic position and a switchover position.
